(19) United States
(12) Patent Application Publication
(10) Pub. No.: US 2009/0291180 A1
(43) Pub. Date: Nov. 26, 2009

(54) Food Preparation Apparatuses, Methods for Constructing Food Preparation Apparatuses, and Methods for Preparing Food

(76) Inventor: Kim Hemphill, Spokane, WA (US)

Correspondence Address: WELLS ST. JOHN P.S., 601 W. FIRST AVENUE, SUITE 1300, SPOKANE, WA, 99201, US

(21) Appl. No.: 12/470,407

(22) Filed: May 21, 2009

Related U.S. Application Data
(60) Provisional application No. 61/055,125, filed on May 21, 2008.

(51) Int. Cl. A23L 1/00; A47J 37/06; B27M 3/00; A23C 3/00

(52) U.S. Cl. 426/506; 99/448; 144/329; 144/359; 426/523

(57) ABSTRACT

Food preparation apparatuses are provided that can include at least two biomass portions coupled together and configured to support edible materials. Methods for constructing food preparation apparatuses are provided that can include harvesting separate biomass portions; and coupling at least two of the portions to construct the food preparation apparatus. Methods for preparing food are provided that can include coupling at least two biomass portions; placing at least one food item over the coupled portions; and heating the portions to prepare the food item.

### CROSS REFERENCE TO RELATED APPLICATION

This application claims priority to U.S. provisional patent application Ser. No. 61/055,125 which was filed on May 21, 2008, the entirety of which is incorporated by reference herein.

### TECHNICAL FIELD

The present disclosure relates to food preparation materials and methods for preparing food.

### BACKGROUND

Food preparation can involve the flavoring of food items. Example flavoring can include the providing of spices and/or flavors such as aromatics to food items such as but not limited to meat items including beef, poultry, and fish. To prepare these items, chefs have utilized the cooking process itself to flavor the food items. Flavors have been provided by smoldering certain materials during the cooking process. Example flavorings can be provided by heating plant materials, dried or otherwise, while heating the food product. Plant materials can include chips and/or boards, for example. These plant materials are becoming more expensive, thereby increasing the cost of food preparation. The present disclosure provides food preparation materials and methods for preparing food.

### BRIEF DESCRIPTION OF THE DRAWINGS

Preferred embodiments of the disclosure are described below with reference to the following accompanying drawings.

FIG. 1 is example raw materials such as forest materials, as well as processed materials.

FIG. 2 is processed materials according to an aspect of the present disclosure.

FIGS. 3 and 4 are example processed materials according to aspects of the present disclosure.

FIGS. 5 and 6 are example processed materials according to the disclosure.

FIG. 7 is an example method for preparing food preparation materials according to an embodiment of the disclosure.

FIGS. 8 and 8a are example methods for utilizing the food preparation materials according to the present disclosure.

### SUMMARY

Food preparation apparatuses are provided that can include at least two biomass portions coupled together and configured to support edible materials.

Methods for constructing food preparation apparatuses are provided that can include harvesting separate biomass portions; and coupling at least two of the portions to construct the food preparation apparatus.

Methods for preparing food are provided that can include coupling at least two biomass portions; placing at least one food item over the coupled portions; and heating the portions to prepare the food item.

### DESCRIPTION

This disclosure is submitted in furtherance of the constitutional purposes of the U.S. Patent Laws “to promote the progress of science and useful arts” (Article 1, Section 8).

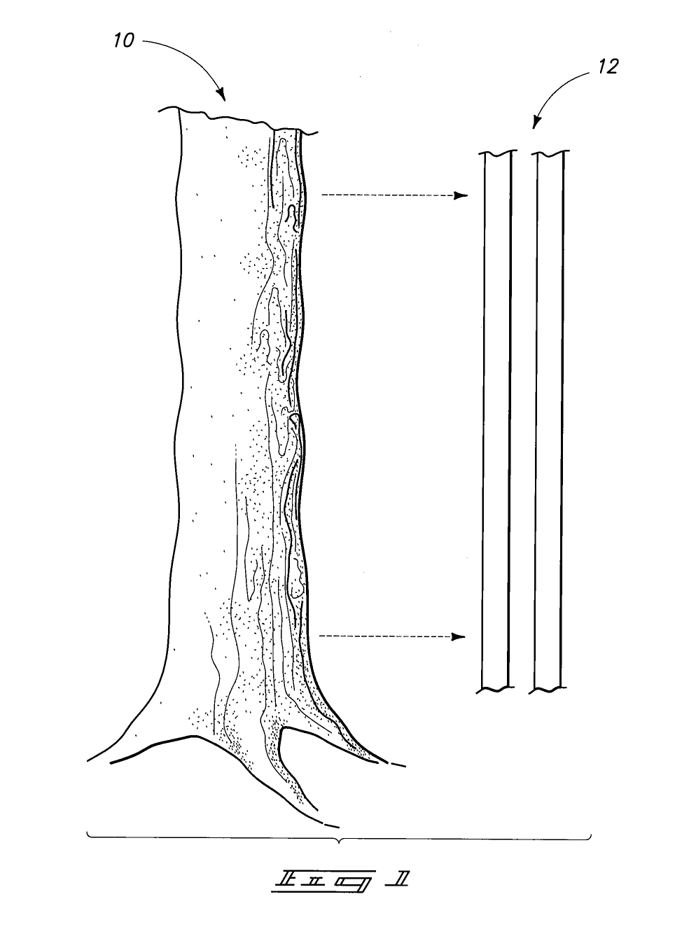

Example food preparation materials and methods are described with reference to FIGS. 1-8A. An example method for constructing a food preparation apparatus can include harvesting separate biomass portions as shown in FIG. 1. These portions can be coupled to construct the food preparation apparatus. The harvesting comprises removing growing biomass having less than an 8 inch diameter. The method can further provide for preparing planks having less than an 8 inch width, some having less than 6 or even less than 4 inches in width. The method can include drying the biomass. The drying can include kilning the biomass, for example.

The method can include preparing at least one edge of one of the separate biomass portions, and preparing at least another edge of another of the biomass portions. The preparing can provide for the coupling the biomass portions. The one and the another edges can be configured to compliment one and the other, for example. The coupling can include coupling the edges of the planks to form an apparatus having width of at least 16, 12, 10, or even 8 inches.

Referring first to FIG. 1, example biomass 10 is shown prior to being processed into boards 12. Example biomass 10 can be any kind of a biomass utilized for cooking applications. Example biomass can include cedar, hickory, and/or alder, for example. Biomass is typically harvested and then processed or cut into processed materials such as boards 12. Boards 12 can have a width dependent on the size of biomass 10 harvested. For example, smaller biomass 10 having less diameter can provide only boards 12 that are smaller in width. As the need for specific biomass such as alder and cedar increases, the cost of providing larger or wider boards 12 increases. Therefore, it is beneficial to be able to utilize boards of lesser width in food preparation applications while still maintaining the support of the food item necessary to prepare the food properly.

Food preparation apparatuses are provided that can include at least two biomass portions coupled together and configured to support edible materials. The individual biomass portions are configured as rectangular planks, for example. In accordance with an embodiment of the disclosure, each of the planks can include an edge. One of the edges of the planks can be configured to receive a portion of another of the edges of the planks, for example. According to a disclosed implementation, one of the edges of the planks can define a recess and the other of the edges of the planks can define an extension to be received by the recess. Each of the biomass portions can include complimentary dovetail edges, for example.

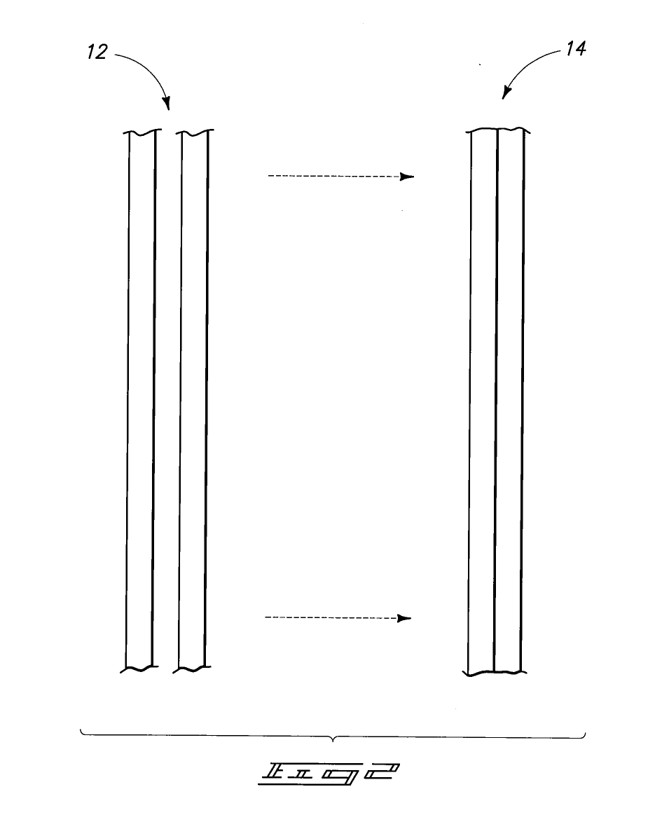

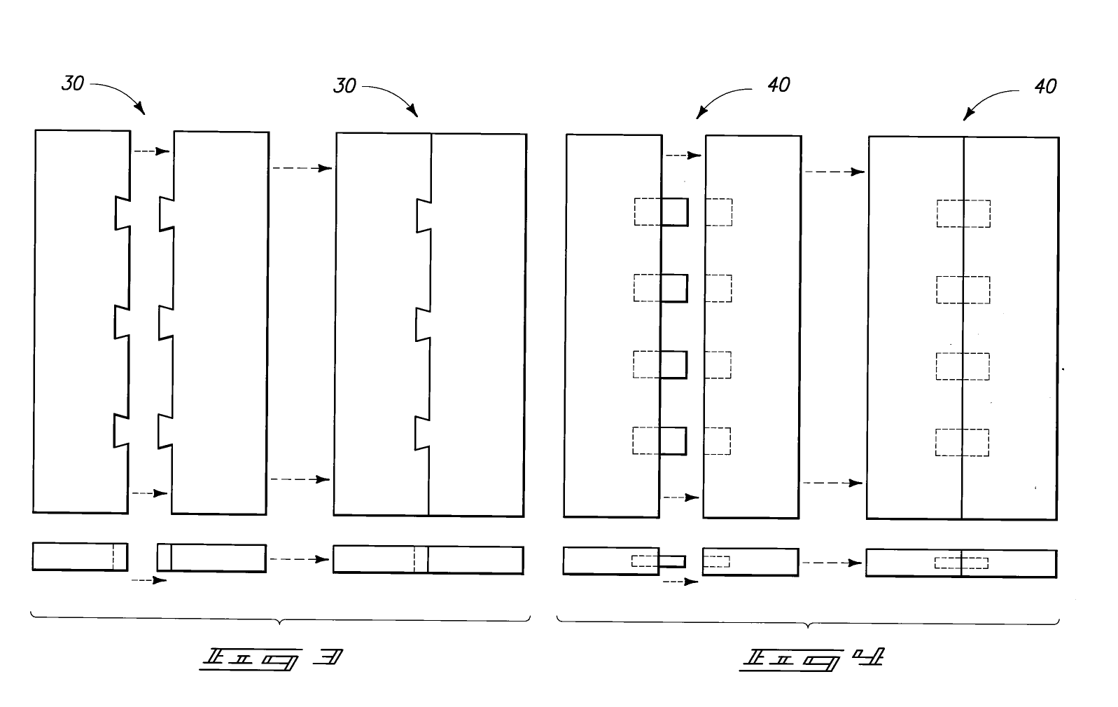

Referring to FIG. 2, boards 12 can be bonded in an edge-to-edge configuration, to form a single board 14 having a width greater than the individual widths of boards 12. This bonding can include complete wood-to-wood bonding. The bonding can also not affect the cooking application. Example bonding and techniques are shown with reference to FIGS. 3-6, for example.

Referring to FIG. 3, boards 30 can be bonded in a dovetail-type fashion to provide interlocking connections between the boards. Referring to FIG. 4, boards can be bonded in a dado configuration to provide interlocking mechanisms between the boards. It is desirable to bond the boards without use of any glue, laminates, or metal bonding or metal materials. Therefore, it is desirable to bond the boards without the addition of materials that may impact the use of the boards in cooking applications.

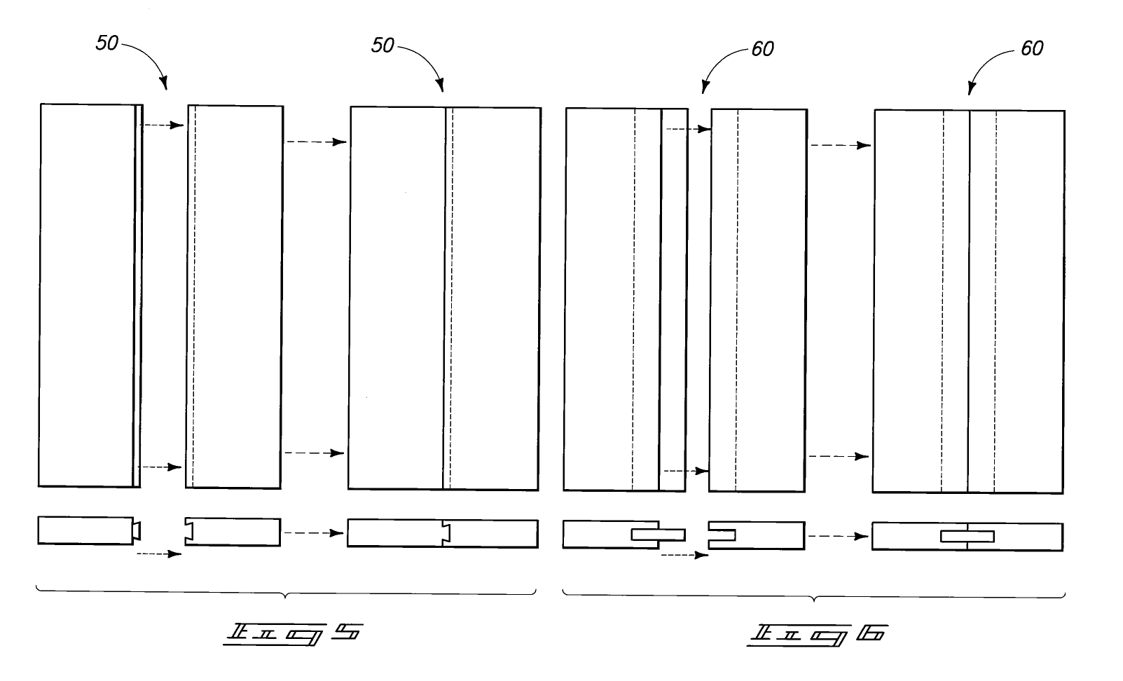

Referring to FIG. 5, boards 50 can be bonded with a lengthwise rabbit and referring to FIG. 6, boards 60 can be bonded with a lengthwise spline, for example. According to example implementations, the spline can be the same material as the material of the boards, or a different material, for example. According to example implementations, the spline can be material that may add or subtract from the providing of flavors during the cooking application. For example, the boards may be constructed of cedar, and the spline may be constructed of alder.

Methods for preparing food are provided, and the method can include coupling at least two biomass portions. The method can also provide for placing at least one food item over the coupled portions and heating the portions to prepare the food item. The coupling can include soaking the portions in an aqueous solution. The aqueous solution can include food preparation seasoning. For example, the solution can include Liquid Smoke® or other seasonings within the solution to enhance the cooking process.

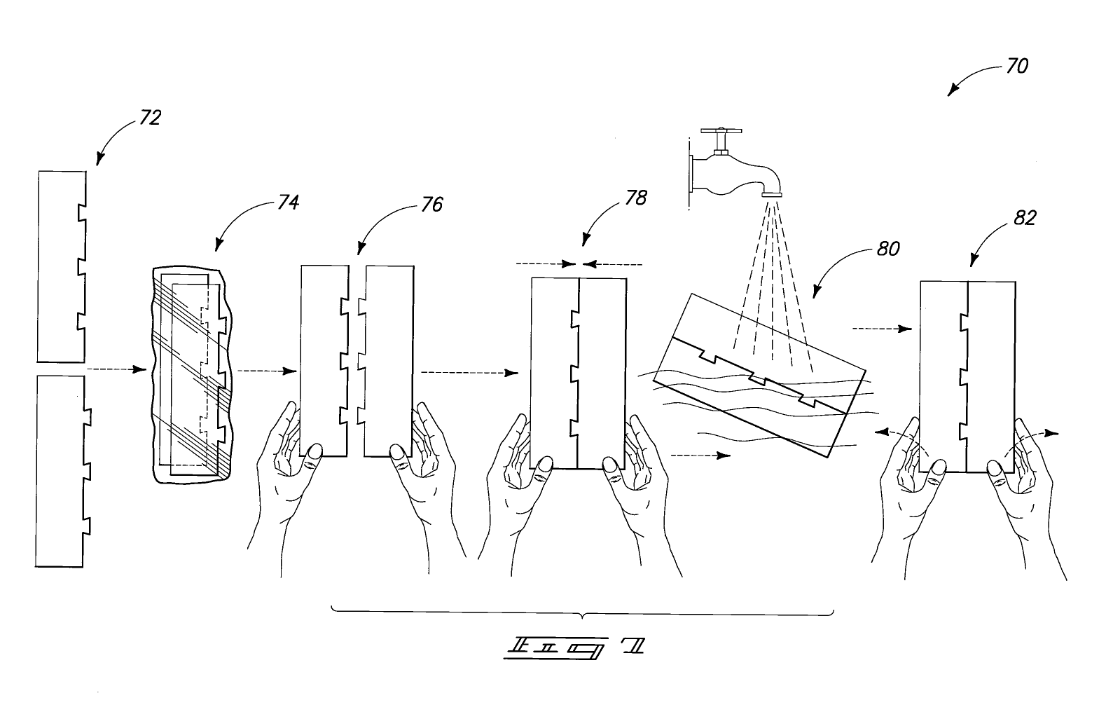

Referring to FIG. 7, boards 72 can be provided and configured to bond edgewise. These boards can be packaged for retail sale. The boards can be removed from the package from the user. The boards can be interlocked or connected together as boards 78, and then in 80, soaked in water. For example, the soaking of the boards in water allows the boards to swell, thereby forming a tight bond between the boards 82 that resists the shear of the boards as shown in 82.

According to example implementations, the providing of water to boards 80, while shown from a faucet, can also be provided by submersing boards 80 into seasoned water or salted water, for example, thereby when utilized as a cooking apparatus, boards 82 can provide even different flavors to food products.

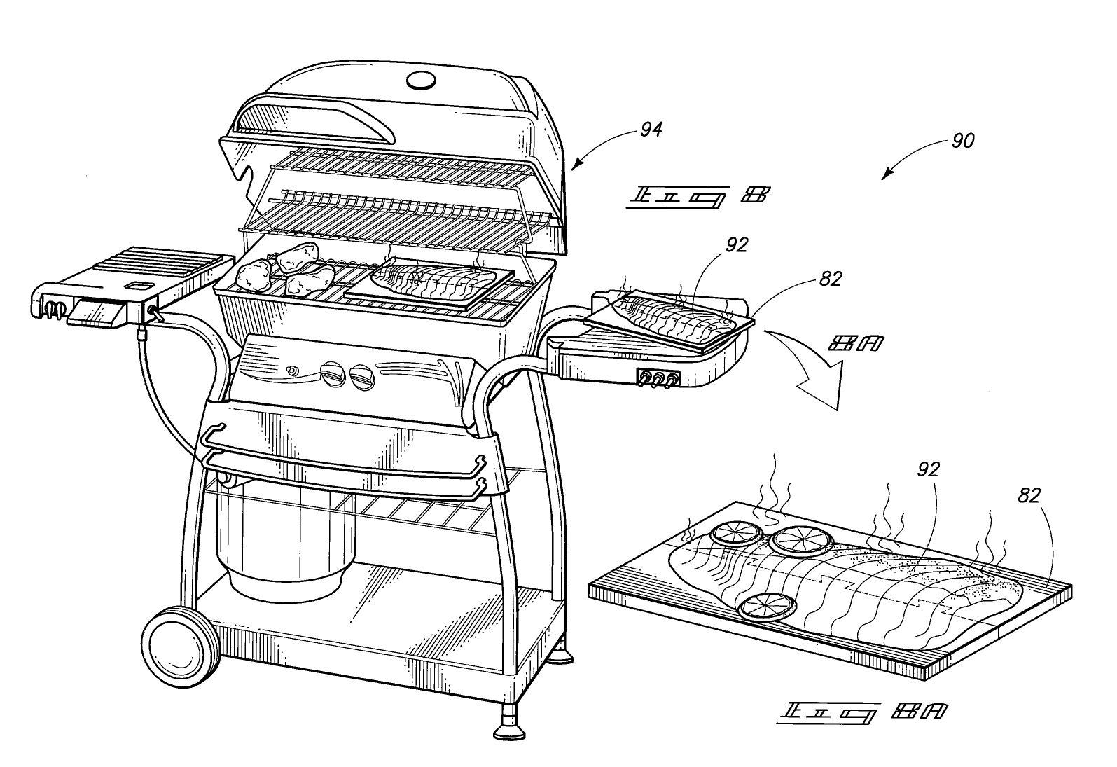

Referring to FIGS. 8 and 8A, food product 92 such as salmon, for example, can be placed above cooking material 82 as prepared as shown in FIG. 7. The combination of food product 92 and cooking apparatus 82 can be provided to a heating apparatus 94. Example heating apparatus include a grill, indoor or outdoor, stovetop, or any other kind of heat source that might provide heat to cooking material 82. As shown in FIG. 8A, cooking material 82 is heated to cook food product 92 and provide flavor to food product 92.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

1. A food preparation apparatus comprising at least two biomass portions coupled together and configured to support edible materials.

2. The apparatus of claim 1 wherein the individual biomass portions are configured as rectangular planks.

3. The apparatus of claim 2 wherein each of the planks include an edge, one of the edges of the planks configured to receive a portion of another of the edges of the planks.

4. The apparatus of claim 3 wherein one of the edges of the planks defines a recess and the other of the edges of the planks defines an extension to be received by the recess.

5. The apparatus of claim 1 wherein each of the biomass portions include complimentary dovetail edges.

6. The apparatus of claim 1 wherein the biomass portion comprises cedar.

7. A method for constructing a food preparation apparatus, the method comprising:
harvesting separate biomass portions; and
coupling at least two of the portions to construct the food preparation apparatus.

8. The method of claim 7 wherein the harvesting comprises removing growing biomass having less than 6 inches diameter.

9. The method of claim 8 further comprising preparing planks having less than 6 inches width.

10. The method of claim 9 wherein the coupling comprises coupling the edges of the planks to form an apparatus having width of at least 8 inches.

11. The method of claim 7 further comprising drying the biomass.

12. The method of claim 11 wherein the drying comprises kilning the biomass.

13. The method of claim 7 further comprising preparing at least one edge of one of the separate biomass portions, and preparing at least another edge of another of the biomass portions, the preparing providing for the coupling the biomass portions.

14. The method of claim 13 wherein the one and another edges are configured to compliment one and the other.

15. A method for preparing food, the method comprising:
coupling at least two biomass portions;
placing at least one food item over the coupled portions; and
heating the portions to prepare the food item.

16. The method of claim 15 wherein the coupling comprises soaking the portions in an aqueous solution.

17. The method of claim 16 wherein the aqueous solution includes food preparation seasoning.

18. The method of claim 15 wherein the biomass portions comprise cedar.

19. The method of claim 15 wherein the biomass of the portions are different.

20. The method of claim 15 wherein one of the biomass portions comprises cedar and another of the biomass portions comprises alder.
